(19) United States
(12) Patent Application Publication
(10) Pub. No.: US 2023/0411103 A1
(43) Pub. Date: Dec. 21, 2023

(54) METHODS FOR FORMING CARBON NANOTUBE/METAL COMPOSITE FILMS AND FIELD EMISSION CATHODES THEREFROM

(71) Applicant: NCX Corporation, Raleigh, NC (US)

(72) Inventor: Cheng QIAN, Cary, NC (US)

(21) Appl. No.: 18/247,266

(22) PCT Filed: Sep. 29, 2021
(86) PCT No.: PCT/IB2021/058938

§ 371 Date: Mar. 29, 2023

Related U.S. Application Data
(60) Provisional application No. 63/085,524, filed on Sep. 30, 2020.

(51) Int. Cl. H01J 9/02; C25D 15/00

(52) U.S. Cl. CPC H01J 9/025; C25D 15/00

(57) ABSTRACT

A method for fabricating an electron field emission cathode, the field emission cathode including a substrate having a field emission layer engaged therewith, where the field emission layer incorporates a carbon nanotube and metal composite film to improve adhesion between the material and the substrate and to improve field emission characteristics of the cathode and field emission cathode devices implementing such cathodes.

### BACKGROUND

### Field of the Disclosure

The present application relates to methods of fabricating field emission cathode devices and, more particularly, to methods of forming field emission cathodes incorporating a carbon nanotube and metal composite film as a field emission matrix material to improve adhesion between the material and a substrate and to improve field emission characteristics of the cathode and field emission cathode devices implementing such cathodes.

### Description of Related Art

A field emission cathode device generally includes a cathode substrate (usually comprised of a metal or other conducting material such as alloy, conductive glass, metalized ceramics, doped silicon), a layer of a field emission material (e.g., nanotubes, nanowires, graphene) disposed on the substrate, and, if necessary, an additional layer of an adhesion material disposed between the substrate and the field emission material. Some typical applications of a field emission cathode device include, for example, electronics operable in a vacuum environment, field emission displays, and X-ray tubes.

Carbon nanotubes may be used in the fabrication of cold field emission cathodes. However, the effective incorporation of carbon nanotubes onto the surface of cathodes has been hindered by difficulties encountered in the processing of carbon nanotube composite films. Current carbon nanotube composite films produced on cathode surfaces have less than desirable characteristics, particularly regarding adhesion strength, conductivity, cleanliness, and defects of the carbon nanotubes.

Thus, there is a need for a process for improving the adhesion of the carbon nanotubes within a matrix material, between the matrix materials and the surface of substrates, and for a process improving the deposition of such carbon nanotube composite films, which results in improved field emission characteristics such as low emission threshold fields, large emission current density and long emission life time. In addition, such a process may reduce or eliminate defects within the carbon nanotubes, resulting in an improved work function of the carbon nanotubes.

### SUMMARY OF THE DISCLOSURE

The above and other needs are met by aspects of the present disclosure which includes, without limitation, the following example embodiments and, in one particular aspect, a method of forming a field emission cathode, where the method includes forming a field emission material by dispersing at least one carbon nanotube, at least one matrix particle, at least one metal salt, and at least one charger in a liquid medium to form a suspension thereof; and depositing a layer of the field emission material on to at least a portion of a substrate via electrophoretic deposition to form the cathode.

Another example aspect provides a method of forming a field emission composite film, where the method includes introducing at least one carbon nanotube into a liquid medium, introducing at least one matrix particle into the liquid medium, introducing at least one metal salt into the liquid medium, introducing at least one charger in the liquid medium; and dispersing the at least one carbon nanotube, the at least one matrix particle, the at least one metal salt, and the at least one charger simultaneously into the liquid medium to form a suspension thereof.

Another example aspect provides another method of forming a field emission cathode, where the method includes depositing a layer of the aforementioned field emission composite film on to at least a portion of a substrate via electrophoretic deposition.

Yet another example aspect provides for a field emission cathode device, where the cathode is fabricated in accordance with any one of the proceeding aspects to obtain a cathode device having improved uniformity of an electric field at a cathode surface, reduced impact from ion bombardment and oxidation, increased conductivity, improved work function of the carbon nanotubes, and improved cathode life time.

The present disclosure thus includes, without limitation, the following example embodiments:

Example Embodiment 1: A method of forming a field emission cathode, comprising forming a field emission material by dispersing at least one carbon nanotube, at least one matrix particle, at least one metal salt, and at least one charger in a liquid medium to form a suspension thereof; and depositing a layer of the field emission material on to at least a portion of a substrate via electrophoretic deposition to form the field emission cathode.

Example Embodiment 2: The method of any preceding example embodiment, or combinations thereof, wherein forming the field emission material comprises forming the field emission material by dispersing the at least one matrix particle comprising a glass particle in the liquid medium.

Example Embodiment 3: The method of any preceding example embodiment, or combinations thereof, wherein dispersing the at least one matrix particle comprises dispersing the at least one matrix particle having a diameter of about 100 nm to about 3 micrometers in the liquid medium.

Example Embodiment 4: The method of any preceding example embodiment, or combinations thereof, wherein dispersing the at least one matrix particle comprises dispersing the at least one matrix particle in the liquid medium at up to 10 wt % of total liquid medium.

Example Embodiment 5: The method of any preceding example embodiment, or combinations thereof, wherein forming the field emission material comprises forming the field emission material by dispersing the at least one metal salt selected from the group consisting of a silver salt, a copper salt, a platinum salt, a bismuth salt, a tungsten salt, a stibium salt, a gold salt, or combinations thereof in the liquid medium.

Example Embodiment 6: The method of any preceding example embodiment, or combinations thereof, wherein dispersing the at least one metal salt comprises dispersing the at least one metal salt in the liquid medium at up to 10 wt % of total liquid medium.

Example Embodiment 7: The method of any preceding example embodiment, or combinations thereof, wherein forming the field emission material comprises forming the field emission material by dispersing the at least one charger selected from the group consisting of a lithium salt, a sodium salt, a calcium salt, a magnesium salt, an aluminum salt, a zinc salt, an iron salt, a cobalt salt, a nickel salt, an ammonium salt, or combinations thereof in the liquid medium.

Example Embodiment 8: The method of any preceding example embodiment, or combinations thereof, wherein dispersing the at least one charger comprises dispersing the at least one charger in the liquid medium at up to 1 wt % of total liquid medium.

Example Embodiment 9: The method of any preceding example embodiment, or combinations thereof, wherein forming the field emission material comprises forming the field emission material by dispersing the at least one carbon nanotube, the at least one matrix particle, the at least one metal salt, and the at least one charger in the liquid medium selected from the group consisting of water, methanol, ethanol, isopropanol, butanol, dimethylformamide (DMF), dimethyl sulfoxide (DMSO), or combinations thereof.

Example Embodiment 10: The method of any preceding example embodiment, or combinations thereof, wherein depositing the layer of the field emission material comprises depositing the layer of the field emission material on to the at least a portion of the substrate comprising a metal, an alloy, a glass, or a ceramic.

Example Embodiment 11: The method of any preceding example embodiment, or combinations thereof, wherein forming the field emission material comprises forming the field emission material by dispersing the at least one carbon nanotube, the at least one matrix particle, the at least one metal salt, and the at least one charger simultaneously in the liquid medium.

Example Embodiment 12: A method of forming a field emission composite, comprising introducing at least one carbon nanotube into a liquid medium; introducing at least one matrix particle into the liquid medium; introducing at least one metal salt into the liquid medium; introducing at least one charger into the liquid medium; and dispersing the at least one carbon nanotube, the at least one matrix particle, the at least one metal salt, and the at least one charger simultaneously into the liquid medium to form a suspension thereof.

Example Embodiment 13: The method of any preceding example embodiment, or combinations thereof, comprising depositing the suspension on to a substrate via electrophoretic deposition.

Example Embodiment 14: The method of any preceding example embodiment, or combinations thereof, wherein introducing the at least one matrix particle comprises introducing the at least one matrix particle comprising a glass particle into the liquid medium.

Example Embodiment 15: The method of any preceding example embodiment, or combinations thereof, wherein dispersing the at least one carbon nanotube comprises dispersing the at least one matrix particle in the liquid medium at up to 10 wt % of total liquid medium.

Example Embodiment 16: The method of any preceding example embodiment, or combinations thereof, wherein introducing the at least one metal salt comprises introducing the at least one metal salt selected from the group consisting of a silver salt, a copper salt, a platinum salt, a bismuth salt, a tungsten salt, a stibium salt, a gold salt, or combination thereof into the liquid medium.

Example Embodiment 17: The method of any preceding example embodiment, or combinations thereof, wherein dispersing the at least one carbon nanotube comprises dispersing the at least one metal salt in the liquid medium at up to 10 wt % of total liquid medium.

Example Embodiment 18: The method of any preceding example embodiment, or combinations thereof, wherein introducing the at least one metal salt comprises introducing the at least one charger selected from the group consisting of a lithium salt, a sodium salt, a calcium salt, a magnesium salt, an aluminum salt, a zinc salt, an iron salt, a cobalt salt, a nickel salt, an ammonium salt, or combinations thereof into the liquid medium.

Example Embodiment 19: The method of any preceding example embodiment, or combinations thereof, wherein dispersing the at least one carbon nanotube comprises dispersing the at least one charger in the liquid medium at up to 1 wt % of total liquid medium.

Example Embodiment 20: The method of any preceding example embodiment, or combinations thereof, wherein introducing the at least one carbon nanotube comprises introducing the at least one carbon nanotube into the liquid medium selected from the group consisting of water, methanol, ethanol, isopropanol, butanol, dimethylformamide (DMF), dimethyl sulfoxide (DMSO), or combinations thereof.

Example Embodiment 21: A method of forming a field emission cathode, comprising depositing a layer of the field emission composite of the method of any preceding example embodiment, or combinations thereof, on to at least a portion of a substrate via electrophoretic deposition to form the field emission cathode.

Example Embodiment 22: A field emission cathode device comprising a cathode fabricated in accordance with the method of any preceding example embodiment, or combinations thereof.

These and other features, aspects, and advantages of the present disclosure will be apparent from a reading of the following detailed description together with the accompanying drawings, which are briefly described below. The present disclosure includes any combination of two, three, four, or more features or elements set forth in this disclosure, regardless of whether such features or elements are expressly combined or otherwise recited in a specific embodiment description herein. This disclosure is intended to be read holistically such that any separable features or elements of the disclosure, in any of its aspects and embodiments, should be viewed as intended, namely to be combinable, unless the context of the disclosure clearly dictates otherwise.

It will be appreciated that the summary herein is provided merely for purposes of summarizing some example aspects so as to provide a basic understanding of the disclosure. As such, it will be appreciated that the above described example aspects are merely examples and should not be construed to narrow the scope or spirit of the disclosure in any way. It will be appreciated that the scope of the disclosure encompasses many potential aspects, some of which will be further described below, in addition to those herein summarized. Further, other aspects and advantages of such aspects disclosed herein will become apparent from the following detailed description taken in conjunction with the accompanying drawings which illustrate, by way of example, the principles of the described aspects.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 schematically illustrates an example of a field emission cathode and the nature of the field emission material deposition layer engaged with the cathode substrate, according to one or more aspects of the present disclosure;

FIG. 2 illustrates one example of a method of forming a field emission composite film, according to one or more aspects of the present disclosure; and

FIG. 3 illustrates one example of a method of forming a field emission cathode, according to one or more aspects of the present disclosure.

### DETAILED DESCRIPTION OF THE DISCLOSURE

The present disclosure now will be described more fully hereinafter with reference to the accompanying drawings, in which some, but not all aspects of the disclosure are shown. Indeed, the disclosure may be embodied in many different forms and should not be construed as limited to the aspects set forth herein; rather, these aspects are provided so that this disclosure will satisfy applicable legal requirements. Like numbers refer to like elements throughout.

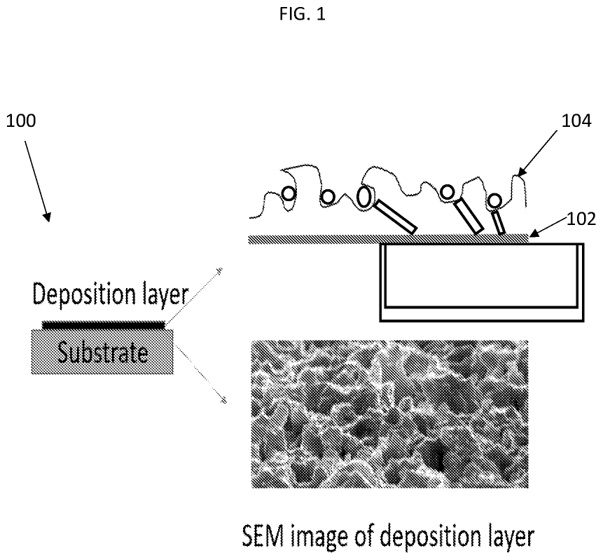

FIG. 1 illustrates one example of a field emission cathode 100 that includes a substrate 102 and a layer of a field emission material 104 disposed on the substrate 102, and, if necessary, an additional layer of an adhesion material (not shown) disposed between the substrate 102 and the field emission material 104. The substrate 102 may be made of an electrically conductive material, such as a metallic material, such as a solid metal or alloy (e.g., stainless steel, doped silicon), conductive glass (e.g., Indium Tin Oxide (ITO) coated glass or other fused glass having a conductive coating on the surface); or a conductive ceramic (e.g., a metalized ceramic, such as aluminum oxide, beryllium oxide, and aluminum nitride). The field emission material 104 is a plurality of carbon nanotubes disposed within a matrix material. The layer of field emission material 104 is formed via deposition of the field emission material on to the substrate 102 by, for example electrophoretic deposition or a similar material processing technique using deposition of charged particles in a stable colloidal suspension on a conductive substrate, such as electro-coating, cathodic electro-deposition, anodic electro-deposition, and electrophoretic coating.

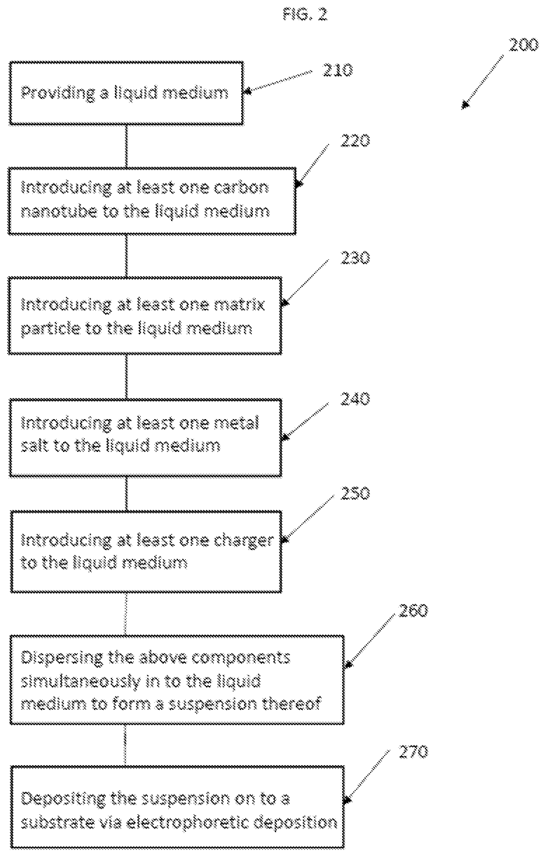

FIG. 2 illustrates a method 200 of forming a field emission composite precursor or composite film precursor. In one aspect of the method, a liquid medium is provided (step 210) into which several components are dispersed. The liquid medium may be selected from the group consisting of water, methanol, ethanol, isopropanol, butanol, dimethylformamide (DMF), dimethyl sulfoxide (DMSO), or combinations thereof. Steps 220, 230, 240, and 250 are directed to introducing the various components, such as at least one carbon nanotube, at least one matrix particle, at least one metal salt, at least one charger to the liquid medium, or combinations thereof. As shown at step 260, all of the preceding components are dispersed within the liquid medium simultaneously so as to form a suspension thereof. The components may be dispersed in the liquid medium in accordance with known methods, such as, for example, sonication or a magnetic stirrer.

The specific composition and quantities of the components may vary to suit a particular application. For example, the at least one matrix particle may be formed from commercially available glass particles that are processed via planetary ball milling to produce glass particles with a diameter of about 100 nm to about 3 micrometers, where the at least one matrix particle is dispersed in the liquid medium at up to 10 wt % of total liquid medium. Additionally, the at least one metal salt may be selected from the group consisting of a silver salt, a copper salt, a platinum salt, a bismuth salt, a tungsten salt, a stibium salt, a gold salt, or combinations thereof, where the at least one metal salt is dispersed in the liquid medium at up to 10 wt % of total liquid medium. The at least one charger may be selected from the group consisting of a lithium salt, a sodium salt, a calcium salt, a magnesium salt, an aluminum salt, a zinc salt, an iron salt, a cobalt salt, a nickel salt, an ammonium salt, or combinations thereof, where the at least one charger is dispersed in the liquid medium at up to 1 wt % of total liquid medium.

Once the field emission composite precursor or composite film precursor has been created in the form of a liquid suspension, the precursor may be deposited on to a substrate via an electrophoretic deposition process (step 270) to provide the field emission composite as a solid form film on the substrate. The film may be subjected to one or more other processes after deposition on the substrate, such as drying, annealing and activating processes. The substrate may be made of a metal, an alloy, a conductive glass, or a metalized ceramic. The substrate may be provided to the appropriate equipment via, for example, a robotic material handling system or manually by a user. The substrate is configured to receive a layer of the field emission composite precursor or composite film precursor thereon.

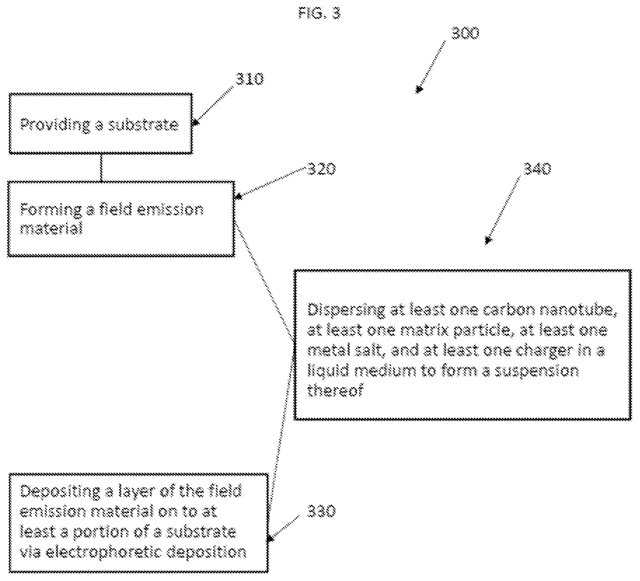

FIG. 3 illustrates a method 300 of forming a field emission cathode using a carbon nanotube and metal composite or composite film. In one aspect of the method, a substrate, such as those described hereinabove, is provided to equipment configured for carrying out a deposition process (step 310). The method further includes forming a field emission material such as a field emission composite precursor or composite film precursor (step 320). In some cases, the field emission material is created prior to the substrate being provided. A layer of the field emission material is deposited on to at least a portion of the substrate via electrophoretic deposition process (step 330) to form a carbon nanotube/metal composite or composite film on the substrate. The film may be subjected to one or more other processes (such as drying annealing and activating) after deposition on the substrate, then the finished product is a field emission cathode. The substrate may be made of a metal, an alloy, a conductive glass, or a metalized ceramic. The substrate may be provided to the appropriate equipment via, for example, a robotic material handling system or manually by a user.

Step 340 illustrates one example of forming the field emission material by dispersing at least one carbon nanotube, at least one matrix particle, at least one metal salt, and at least one charger into a liquid medium to form a suspension thereof. The dispersion of the at least one carbon nanotube, the at least one matrix particle, the at least one metal salt, and the at least one charger into the liquid medium occurs simultaneously by, for example, sonication, a magnetic stirrer, or similar.

The specific composition and quantities of the components may vary to suit a particular application. For example, the at least one matrix particle may be formed from commercially available glass particles that are processed via planetary ball milling to produce glass particles with a diameter of about 100 nm to about 3 micrometers, where the at least one matrix particle is dispersed in the liquid medium at up to 10 wt % of total liquid medium. Additionally, the at least one metal salt may be selected from the group consisting of a silver salt, a copper salt, a platinum salt, a bismuth salt, a tungsten salt, a stibium salt, a gold salt, or combinations thereof, where the at least one metal salt is dispersed in the liquid medium at up to 10 wt % of total liquid medium. The at least one charger may be selected from the group consisting of a lithium salt, a sodium salt, a calcium salt, a magnesium salt, an aluminum salt, a zinc salt, an iron salt, a cobalt salt, a nickel salt, an ammonium salt, or combinations thereof, where the at least one charger is dispersed in the liquid medium at up to 1 wt % of total liquid medium. The carbon nanotubes may be manufactured by a chemical vapor deposition process, a laser ablation process, and/or an arc discharge method.

The foregoing methods provide for the homogeneous deposition of a composite film of carbon nanotubes and metals by co-depositing carbon nanotubes and metals onto a substrate by an electrophoretic deposition process. The methods improve not only the adhesion of the carbon nanotubes to the substrate, but also the conductivity of the carbon nanotube/metal composite films and the electron field emission cathodes made therewith. The methods also improve the work function of carbon nanotubes by the surface modification of carbon nanotubes in the fabricating process.

The carbon nanotube/metal composite films, electron field emission cathodes, and electron field emission cathode device, such as vacuum devices, fabricated by these processes demonstrate enhanced electron field emission characteristics, such as increased conductivity of layers of the field emission material and improved uniformity of the electric field at the cathode surface.

Many modifications and other embodiments of the inventions set forth herein will come to mind to one skilled in the art to which these disclosed embodiments pertain having the benefit of the teachings presented in the foregoing descriptions and the associated drawings. Therefore, it is to be understood that embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure. In this regard, for example, different combinations of elements and/or functions than those explicitly described above are also contemplated within the scope of the disclosure. Although specific terms are employed herein, they are used in a generic and descriptive sense only and not for purposes of limitation.

It should be understood that although the terms first, second, etc. may be used hereinto describe various steps or calculations, these steps or calculations should not be limited by these terms. These terms are only used to distinguish one operation or calculation from another. For example, a first calculation may be termed a second calculation, and, similarly, a second step may be termed a first step, without departing from the scope of this disclosure. As used herein, the term “and/or” and the “I” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

1. A method of forming a field emission cathode, comprising:
forming a field emission material by dispersing at least one carbon nanotube, at least one matrix particle, at least one metal salt, and at least one charger in a liquid medium to form a suspension thereof; and
depositing a layer of the field emission material on to at least a portion of a substrate via electrophoretic deposition to form the field emission cathode.

2. The method of claim 1, wherein forming the field emission material comprises forming the field emission material by dispersing the at least one matrix particle comprising a glass particle in the liquid medium.

3. The method of claim 1, wherein dispersing the at least one matrix particle comprises dispersing the at least one matrix particle having a diameter of about 100 nm to about 3 micrometers in the liquid medium.

4. The method of claim 1, wherein dispersing the at least one matrix particle comprises dispersing the at least one matrix particle in the liquid medium at up to 10 wt % of total liquid medium.

5. The method of claim 1, wherein forming the field emission material comprises forming the field emission material by dispersing the at least one metal salt selected from the group consisting of a silver salt, a copper salt, a platinum salt, a bismuth salt, a tungsten salt, a stibium salt, a gold salt, or combinations thereof in the liquid medium.

6. The method of claim 1, wherein dispersing the at least one metal salt comprises dispersing the at least one metal salt in the liquid medium at up to 10 wt % of total liquid medium.

7. The method of claim 1, wherein forming the field emission material comprises forming the field emission material by dispersing the at least one charger selected from the group consisting of a lithium salt, a sodium salt, a calcium salt, a magnesium salt, an aluminum salt, a zinc salt, an iron salt, a cobalt salt, a nickel salt, an ammonium salt, or combinations thereof in the liquid medium.

8. The method of claim 1, wherein dispersing the at least one charger comprises dispersing the at least one charger in the liquid medium at up to 1 wt % of total liquid medium.

9. The method of claim 1, wherein forming the field emission material comprises forming the field emission material by dispersing the at least one carbon nanotube, the at least one matrix particle, the at least one metal salt, and the at least one charger in the liquid medium selected from the group consisting of water, methanol, ethanol, isopropanol, butanol, dimethylformamide (DMF), dimethyl sulfoxide (DMSO), or combinations thereof.

10. The method of claim 1, wherein depositing the layer of the field emission material comprises depositing the layer of the field emission material on to the at least a portion of the substrate comprising a metal, an alloy, a glass, or a ceramic.

11. The method of claim 1, wherein forming the field emission material comprises forming the field emission material by dispersing the at least one carbon nanotube, the at least one matrix particle, the at least one metal salt, and the at least one charger simultaneously in the liquid medium.

12. A method of forming a field emission composite, comprising:
introducing at least one carbon nanotube into a liquid medium;
introducing at least one matrix particle into the liquid medium;
introducing at least one metal salt into the liquid medium;
introducing at least one charger into the liquid medium; and
dispersing the at least one carbon nanotube, the at least one matrix particle, the at least one metal salt, and the at least one charger simultaneously into the liquid medium to form a suspension thereof.

13. The method of claim 12, comprising depositing the suspension on to a substrate via electrophoretic deposition.

14. The method of claim 12, wherein introducing the at least one matrix particle comprises introducing the at least one matrix particle comprising a glass particle into the liquid medium.

15. The method of claim 12, wherein dispersing the at least one carbon nanotube comprises dispersing the at least one matrix particle in the liquid medium at up to 10 wt % of total liquid medium.

16. The method of claim 12, wherein introducing the at least one metal salt comprises introducing the at least one metal salt selected from the group consisting of a silver salt, a copper salt, a platinum salt, a bismuth salt, a tungsten salt, a stibium salt, a gold salt, or combination thereof into the liquid medium.

17. The method of claim 12, wherein dispersing the at least one carbon nanotube comprises dispersing the at least one metal salt in the liquid medium at up to 10 wt % of total liquid medium.

18. The method of claim 12, wherein introducing the at least one charger comprises introducing the at least one charger selected from the group consisting of a lithium salt, a sodium salt, a calcium salt, a magnesium salt, an aluminum salt, a zinc salt, an of 8 iron salt, a cobalt salt, a nickel salt, an ammonium salt, or combinations thereof into the liquid medium.

19. The method of claim 12, wherein dispersing the at least one carbon nanotube comprises dispersing the at least one charger in the liquid medium at up to 1 wt % of total liquid medium.

20. The method of claim 12, wherein introducing the at least one carbon nanotube comprises introducing the at least one carbon nanotube into the liquid medium selected from the group consisting of water, methanol, ethanol, isopropanol, butanol, dimethylformamide (DMF), dimethyl sulfoxide (DMSO), or combinations thereof.

21. A method of forming a field emission cathode, comprising:
introducing at least one carbon nanotube into a liquid medium;
introducing at least one matrix particle into the liquid medium;
introducing at least one metal salt into the liquid medium;
introducing at least one charger into the liquid medium;
dispersing the at least one carbon nanotube, the at least one matrix particle, the at least one metal salt, and the at least one charger simultaneously into the liquid medium to form a suspension thereof, the suspension comprising a field emission composite; and
depositing a layer of the field emission composite on to at least a portion of a substrate via electrophoretic deposition to form the field emission cathode.

22. The method of claim 21, wherein introducing the at least one matrix particle comprises introducing the at least one matrix particle comprising a glass particle into the liquid medium.

23. The method of claim 21, wherein dispersing the at least one carbon nanotube comprises dispersing the at least one matrix particle in the liquid medium at up to 10 wt % of total liquid medium.

24. The method of claim 21, wherein introducing the at least one metal salt comprises introducing the at least one metal salt selected from the group consisting of a silver salt, a copper salt, a platinum salt, a bismuth salt, a tungsten salt, a stibium salt, a gold salt, or combination thereof into the liquid medium.

25. The method of claim 21, wherein dispersing the at least one carbon nanotube comprises dispersing the at least one metal salt in the liquid medium at up to 10 wt % of total liquid medium.

26. The method of claim 21, wherein introducing the at least one charger comprises introducing the at least one charger selected from the group consisting of a lithium salt, a sodium salt, a calcium salt, a magnesium salt, an aluminum salt, a zinc salt, an iron salt, a cobalt salt, a nickel salt, an ammonium salt, or combinations thereof into the liquid medium.

27. The method of claim 21, wherein dispersing the at least one carbon nanotube comprises dispersing the at least one charger in the liquid medium at up to 1 wt % of total liquid medium.

28. The method of claim 21, wherein introducing the at least one carbon nanotube comprises introducing the at least one carbon nanotube into the liquid medium selected from the group consisting of water, methanol, ethanol, isopropanol, butanol, dimethylformamide (DMF), dimethyl sulfoxide (DMSO), or combinations thereof.
